(19) United States
(12) Patent Application Publication
(10) Pub. No.: US 2026/0220491 A1
(43) Pub. Date: Jul. 30, 2026

(54) SYSTEMS AND METHODS FOR GENERATING STEP SPECIFIC INSIGHT FACTORS

(71) Applicant: Walmart Apollo, LLC, Bentonville, AR (US)

(72) Inventors: Aysenur Inan, Mountain View, CA (US); Reza Yousefi Maragheh, Los Altos, CA (US); Jayesh Uddhav Kudase, Santa Clara, CA (US); Jianpeng Xu, Cupertino, CA (US); Hyun Duk Cho, San Francisco, CA (US); Sushant Kumar, San Jose, CA (US); Kannan Achan, Saratoga, CA (US); Charan Chand Irugu, Milpitas, CA (US)

(21) Appl. No.: 19/040,541

(22) Filed: Jan. 29, 2025

(51) Int. Cl. G06N 5/01; G06N 3/0475

(52) U.S. Cl. CPC G06N 5/01; G06N 3/0475

(57) ABSTRACT

In some embodiments, apparatuses and methods are provided herein useful to provide data generation and abstraction for items of a platform. Some embodiments, system may include a database storing data associated with a plurality of items, a processing resource, and a machine readable medium storing instructions that when executed cause the processing resource to: generate, using a first trained model, a first prompt to query at least one LLM to design a series of steps to determine one or more insights associated with a target item; receive the series of steps from the at least one LLM; generate, using an additional trained model, a step specific prompt to query the at least one LLM to provide a step specific insight factor; receive the step specific insight factor; and output data to cause a display of a user device to display the target item and the insight.

### TECHNICAL FIELD

This disclosure relates generally to network platforms and more specifically to items of an item acquisition platform.

### BACKGROUND

Many e-commerce platforms (e.g., websites and/or applications associated with a retailer) include personalization system to suggest products to customers. Currently, personalization systems rely on static attribute items (e.g., brand, flavor, etc.) and transactional data (e.g., customer order history) to generate recommendations for customers. As a result, customer personalization may be limited, especially when there is a lack of transactional data. As such, a need exists for systems and methods for improved personalization systems for e-commerce platforms.

### BRIEF DESCRIPTION OF DRAWINGS

Disclosed herein are embodiments of systems, apparatuses and methods pertaining to data generation and abstraction of products of a network platform. This description includes drawings, wherein:

FIG. 1 is a block diagram of an insight factor generation system in accordance with some embodiments.

FIG. 2A is a block diagram of use of an insight factor generation system in accordance with several embodiments.

FIG. 2B is a block diagram of use of an insight factor generation system in accordance with several embodiments.

FIG. 3 is a block diagram of an insight factor generation system in accordance with some embodiments.

FIG. 4 is a block diagram of an insight factor generation system in accordance with several embodiments.

FIG. 5 is a block diagram of an insight factor generation system in accordance with some embodiments.

FIG. 6 is a block diagram of an insight factor generation system in accordance with several embodiments.

FIG. 7 is a flow diagram showing a method executed by the insight factor generation system of FIG. 6 in accordance with some embodiments.

FIG. 8A is a flow diagram showing a method of insight factor generation in accordance with several embodiments.

FIG. 8B is a flow diagram of a method of insight factor generation in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses, and methods are provided herein useful to data generation and abstraction of products of a network platform. In some embodiments, a system includes: a database storing data associated with a plurality of items, a processing resource, and a machine readable medium storing instructions. The instructions, when executed by the processing resource, cause the processing resource to: generate, using a first trained model, a first prompt to query at least one large language model (LLM) to design a series of steps to be performed by additional trained models to determine one or more insights associated with the plurality of items based on at least one of item descriptions and textual information associated with the plurality of items, wherein each step includes a step specific prompt to be used to query the at least one LLM; receive the series of steps from the at least one LLM; generate, for each of the series of steps using an additional trained model, the step specific prompt with data corresponding to a target item to query the at least one LLM to provide a step specific insight factor with respect to the target item; receive, for each of the series of steps, the step specific insight factor with respect to the target item, wherein a last step specific insight factor of a plurality of step specific insights comprises an insight of the one or more insights for the target item; and output data to cause a display of a user device to display the target item, the at least one of item descriptions and the textual information, and the insight.

In some embodiments, a method includes: generating, using a first trained model, a first prompt to query at least one large language model (LLM) to design a series of steps to be performed by additional trained models to determine one or more insights associated with a plurality of items based on at least one of item descriptions and textual information associated with the plurality of items, wherein each step includes a step specific prompt to be used to query the at least one LLM; generating, for each of the series of steps using an additional trained model, the step specific prompt with data corresponding to a target item to query the at least one LLM to provide a step specific insight factor with respect to the target item; receiving, for each of the series of steps, the step specific insight factor with respect to target item, wherein a last step specific insight factor of a plurality of step specific insights comprises an insight of the one or more insights for the target item; and outputting data to cause a display of a user device to display the target item, the at least one of item descriptions and the textual information, and the insight.

In some embodiments, a non-transitory machine readable medium storing instructions for a system, when executed, causes a processing resource to: generate, using a first trained model, a first prompt to query at least one large language model (LLM) to design a series of steps to be performed by additional trained models to determine one or more insights associated with a plurality of items based on at least one of item descriptions and textual information associated with the plurality of items, wherein each step includes a step specific prompt to be used to query the at least one LLM; generate, for each of the series of steps using an additional trained model, the step specific prompt with data corresponding to a target item to query the at least one LLM to provide a step specific insight factor with respect to the target item; receive, for each of the series of steps, the step specific insight factor with respect to target item, wherein a last step specific insight factor of a plurality of step specific insights comprises an insight of the one or more insights for the target item; and output data to cause a display of a user device to display the target item, the at least one of item descriptions and the textual information, and the insight.

The following description is not to be taken in a limiting sense, but is made merely for the purpose of describing the general principles of example embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in but is not limited to at least one embodiment. Thus, appearances of the phrases “in one embodiment,” “in an embodiment,” “in some embodiments”, “in some implementations”, and similar language throughout this specification may, but do not necessarily, all refer to the same embodiment.

Conventional network platforms, such as e-commerce platforms, may have sub-optimal personalization systems that rely on static item attributes (e.g., brand, flavor, color) which limit recommendations for users (e.g., customers). Further, conventional systems may often struggle to identify user intent beyond transactional data (e.g., purchase history) especially when there is minimal to no purchase history available. On the contrary, the present disclosure describes systems and methods which utilize machine learning models (e.g., large language models (LLMs)) to extract dynamic insights from non-transactional data (e.g., product descriptions, product reviews, etc.), generating item insights including: use cases (e.g., potential uses for an item), personas (e.g., a typical user of an item), highlights (e.g., words and/or phrases that capture an item's main selling points or attributes), reasoning (e.g., why a user may purchase an item), and so forth. Generally, the insights generated may improve the relevancy of personalization by considering broader, dynamic customer motivations. The present disclosure generally describes a scalable framework able to map item insights to customer preferences for improvement of recommendation personalization even in the absence of historical customer interactions. By associating items based on shared insights, the framework may uncover new relationships between seemingly unrelated items, enhancing a user's shopping experience by presenting relevant but diverse item options.

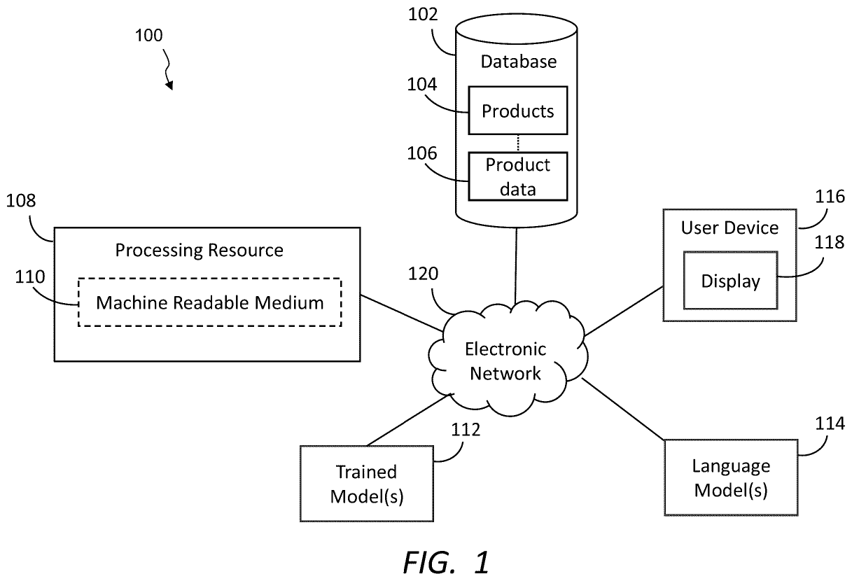

FIG. 1 shows a system 100 for data generation and abstraction in accordance with some embodiments. The system 100 includes at least one database 102, at least one processing resource 108 (e.g., which executes instructions stored in a machine readable medium 110), at least one trained model 112, at least one language model 114, and at least one user device 116 communicatively coupled over a network 120. Generally, the system 100 abstracts dynamic insights from data 106 associated with products 104 (more generically referred to as items) of an e-commerce platform (more generically referred to as a network platform). Generally, the e-commerce platform provides a plurality of products 104 available for purchase by a user (e.g., a customer) navigating the e-commerce platform (e.g., a website, a mobile application, and the like). In some embodiments, this may be more generically referred to as the network platform providing a plurality of items available for acquisition by a user navigating a network platform.

The database(s) 102 may be any suitable databases (e.g., hierarchical databases, relational databases, non-relational databases, object oriented databases, and so forth) configured to store data relevant to the system 100. In some embodiments, data stored in the database(s) 102 includes product data 106 (e.g., product pricing, number of SKUs of a product available, historical sales information of a product, product name, product description, product reviews, interaction history, textual information, product insights, etc.) associated with a plurality of products 104 for sale, training and/or retraining data to be used by the language models 114 and/or the trained models 112, and so forth. Any suitable data relevant to the systems and processes described herein may be stored in one or more databases 102.

The processing resource(s) 108 may include any suitable processing resource configured to execute instructions stored in a computer-readable storage memory (e.g., random access memory, read-only memory, hard disk drive, solid-state drive, optical disc, storage network, network-attached storage, storage area network, and/or any non-transitory, computer-readable storage medium). In this context, the terms processing resource 108, control circuit, and controller may refer broadly to any microcontroller, computer, or processor-based device with processor, memory, and programmable input/output peripherals, which is generally designed to govern the operation of other components and devices. It is further understood that the processing resource 108, control circuit, and/or controller may be operatively coupled to common accompanying accessory devices, including memory, transceivers for communication with other components and devices, etc. The common accompanying accessory devices, including memory, transceivers for communication with other components and devices are architectural options that are well known and understood in the art and require no further description here. The processing resource 108 or controller may be configured to carry out one or more of the steps, actions, and/or functions described herein.

In some aspects, instructions executable by the processing resource 108 are stored in a computer readable storage memory (e.g., the machine readable medium 110). The machine readable medium(s) 110 may store any additional data relevant to the system 100 (e.g., product data 106, training data, historical inputs, customer data, and the like). Examples of suitable machine readable mediums 110 includes random access memory (RAM), read-only memory (ROM), erasable programmable read-only memory (EPROM/flash memory), and so forth, and may include transient and/or non-transient mediums. The machine readable medium 110 typically includes one or more processor-readable and/or computer-readable media accessed by at least the processing resource 108, and can include volatile and/or nonvolatile media, such as RAM, ROM, EEPROM, flash memory and/or other memory technology. The machine readable medium 110 memory can be internal (as shown in FIG. 1), external, or a combination of internal and external memory of the processing resource 108.

The trained model(s) 112, in some embodiments, are machine learning agents (e.g., LLM agents) which execute the functions described herein. In the present embodiment, the trained model 112 is operatively coupled with the processing resource 108 via the network 120, and the processing resource 108 may execute the trained model 112. For example, the trained models 112 may be systems built on top of a machine learning model (e.g., the language models 114) that may interact with external tools and application programming interfaces (APIs). In other words, a machine learning agent can use external tools to perform actions beyond text generation (e.g., utilizing search engines on the internet). A machine learning agent may further maintain a state and/or context across multiple steps by calling a machine learning model multiple times and recalling the input(s) and/or output(s) of each call. In some aspects, a machine learning agent autonomously works toward specific goals (e.g., by planning a series of steps and delegating the steps to additional machine learning models). In other words, a machine learning agent utilizes machine learning models along with additional tools (e.g., open source resources, search engines, additional models, etc.) in order to complete tasks. In some embodiments, the trained models 112 described herein are machine learning agents communicating with additional machine learning models. The trained models 112 are generally pre-trained with data, and in some embodiments may be re-trained by any combination of manually input re-training data and/or self-learning methods. Generally, the trained models 112 are in communication with the language models 114.

The language model(s) 114 may be trained using any suitable machine learning algorithm(s) including decision trees, random forest, neural networks, deep learning, and so forth. In the present embodiment, the language model 114 is operatively coupled with the processing resource 108 via the network 120, and the processing resource 108 may execute the language model 114. In some embodiments, instructions stored in memory (e.g., of the processing resource 108 and/or external memory) may cause the processing resource 108 to output information and/or data from the user device(s) 116, the database(s) 102, and/or the machine readable medium(s) 110 to be used by the language model(s). The language model 114 is generally pre-trained with data, and in some embodiments may be re-trained by any combination of manually input re-training data and/or self-learning methods. In some embodiments, the language model(s) 114 are large language models (LLMs). In some embodiment, the LLMs may be trained by third parties and residing and executed in a third party cloud server environment. Example third party LLMs include: GPT-4 and ChatGPT from OpenAI; BERT, T5, Bard from Google; Claude 3.5; Llama from Meta, Bing Chat from Microsoft. In some embodiments, the language models 114 may be downloaded from third parties and trained using data specific to the system 100 and executed on server/s controlled by the system 100 developer. It is understood that the trained models 112 and the language models 114 are stored in respective machine readable mediums and executed by respective processing resources.

The user device(s) 116 may be operatively coupled to the any described components of the system 100 and may include, but are not limited to, smartphones, tablets, laptops, computers, and/or other such computing systems that enable a user to communicate with the system 100. In some aspects, one or more user devices 116 may be part of the system 100 and/or one or more user devices 116 may be separate and distinct from the system 100. The system 100 can further include and/or be in communication with one or more networks 120. The user device(s) 116 can allow a user to interact with the system 100 and receive information through the system 100. In some instances, the user device 116 includes a display 118 and/or one or more user inputs, such as buttons, touch screen, track ball, keyboard, mouse, etc., which can be part of or wired or wirelessly coupled with the system 100. In some aspects, the user device(s) 116 is a mobile device. Exemplary mobile devices may include, but are not limited to, cellular telephones, smartphones, tablets, portable computers, laptop computers, personal digital assistants, wearable devices, watches, eyeglasses, goggles, media players vehicle displays, and the like.

The network 120 may be any suitable network or communication method such as, for example, a local area network (LAN), the Internet, wide area network (WAN), etc., communication link, other networks or communication channels with other devices and/or other such communications (not shown) or combination of two or more of such communication methods. There may be any combination of wired connections and/or wireless connections (e.g., Wi-Fi, Bluetooth, cellular, RF, and/or other such wireless communication) between elements of the system 100.

It is noted that while certain terms are used throughout the specification and figures, they may be referred to and defined more generically. For example, in some embodiments, one or more of: an e-commerce platform may be more generically referred to as a network platform (or a platform); a product may be more generically referred to as an item; a target product may be more generically referred to as a target item; a product order may be more generically referred to as an item acquisition request; product data may be more generically referred to as data or item data; product descriptions may be more generically referred to as item descriptions; and so forth.

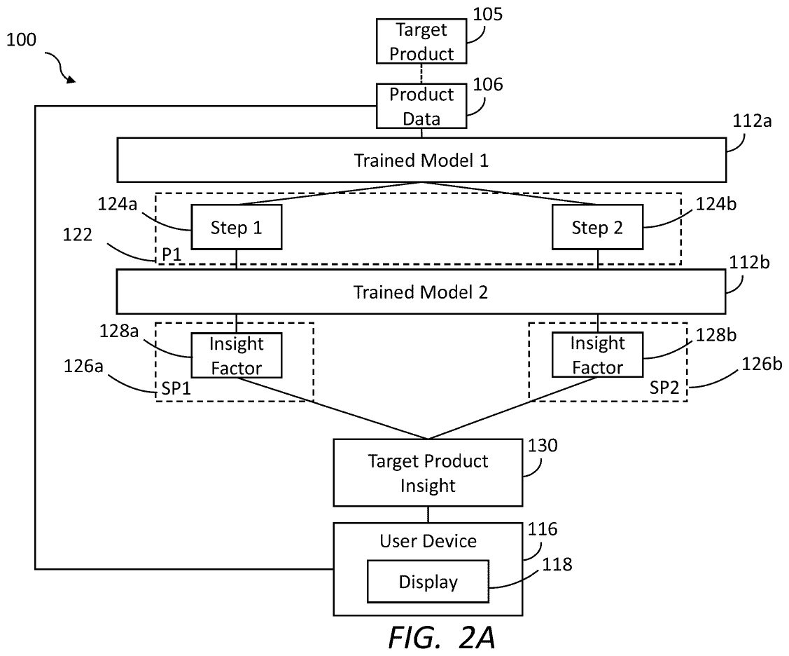

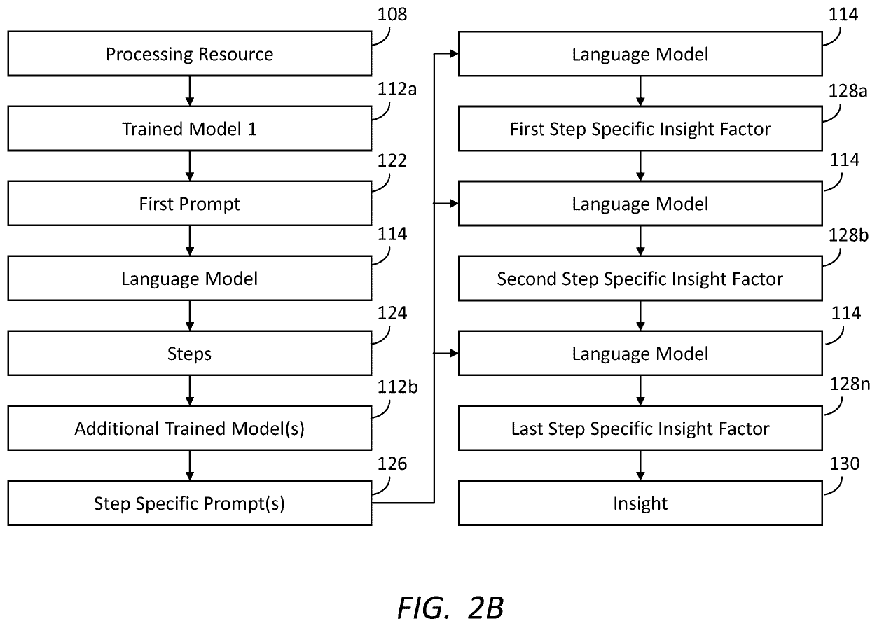

Further referring to FIGS. 2A and 2B, the system 100 is shown in accordance with some embodiments. In some aspects, the system 100 further includes a first trained model 112a and at least one additional model 112b. While the additional model 112b is shown to be one trained model 112, it is generally contemplated that there may be any number of additional models 112b. Generally, instructions stored in the machine readable medium 110, when executed by the processing resource 108, cause the processing resource 108 to perform the actions shown in FIGS. 2A and 2B. In some aspects, FIGS. 2A and 2B show the generation of an insight 130 for a target product 105, e.g., of the products 104 (wherein the target product may be referred to more generically as a target item).

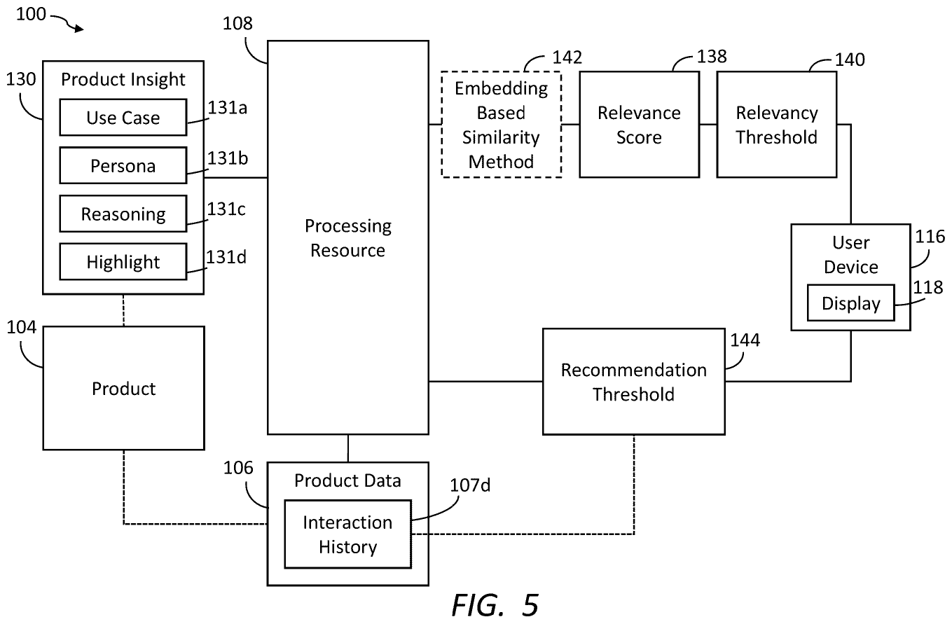

The insight 130 is generally a dynamic insight abstracted/generated from non-transactional data (e.g., product descriptions, product reviews, product name, which may be referred to more generically as item descriptions, item reviews, item name). For example, as shown in FIG. 5, the insight 130 may include one or more of a use case 131a (e.g., potential uses for an item) of the target product 105, a persona 131b (e.g., a typical user of an item) of the target product 105, a highlight 131d (e.g., words and/or phrases that capture an item's main selling points or attributes) of the target product 105, and/or a reasoning 131c (e.g., why a user may purchase an item) of the target product 105. It is generally contemplated that the types of insights 130 (e.g., 131a, 131b, 131c, 131d) described are non-exhaustive, and that the type of insights 130 generated by the system 100 may be varied (e.g., to remove an insight 130, to add a new inside 130, to change an insight 130, and so forth). In some aspects, the insights 130 generated may include any combination of the types of insight (e.g., 131a, 131b, 131c, 131d) including one of each type of insight, multiple of a type of insight, a select combination of the types of insights, and so forth.

Referring again to FIG. 2A, the first trained model 112a is a machine learning agent in accordance with some embodiments. In some aspects, the first trained model 112a generates (e.g., in cooperation with the processing resource 108) a first prompt 122 to query at least one large language model (e.g., a language model 114) to design a series of steps 124 (e.g., a first step 124a and a second step 124b) to be performed by additional trained models 112b. In other words, the first trained model 112a designs the multiple step 124 process to extract insights 130 from product data 106 associated with a target product 105. In some aspects, the first trained model 112a receives a template prompt, and the first trained model 112a populates the template prompt with information specific to the target product 105 and the type of insight 130 being extracted to generate the first prompt 122. In some aspects, the first trained model 112a generates a first prompt 122 to be executed by at least one language model 114. In some aspects, the first trained model 112a facilitates the generation of the first prompt 122 by at least one language model 114 cooperating with the first trained model 112a. In some aspects, the first trained model 112a may be considered a planner agent.

The first prompt 122 is generally a textual prompt in accordance with some embodiments. The first prompt 122 may describe the role of the first trained model 112a, the tasks to be performed by the first trained model 112a, requirements for the output from the first trained model 112a, detailed descriptions of what should be provided from each task, examples, desired outcomes, etc. An example first prompt 122 to the first trained model 112a may read “You are a Planning Agent responsible for designing a multi-step process to extract user insights from product descriptions and textual information. Your task is to: 1. Break down the insight extraction process into logical steps; 2. Generate specific prompts for each step; 3. Define the role and responsibility of the agent handling each step; 4. Specify how the output of each step should be formatted and passed to the next step”. In some aspects, example requirements to be followed may include: the steps 124 being clear and sequential, each step specific prompt 126 being self-contained (e.g., not dependent on the other step specific prompts 126), the final output should identify specific insights 130 based on product data 106, the response should be formatted as follows, and so on. Generally, the first prompt 122 specifies the target product 105 that the insight 130 is to be generated for.

In some aspects, the series of steps 124 is used to determine one or more insights 130 associated with at least one of the plurality of products 104 of the e-commerce platform. An example formatting of a step 124 may be “STEP NUMBER: [step number]; AGENT ROLE: [specialized role for this step]; PURPOSE: [what this step accomplished]; INPUT: [what input this step receives]; PROMPT: [the actual prompt to use]; OUTPUT FORMAT: [how the output should be structured]: PASSES TO: [next step number]”. In some embodiments, as shown in FIG. 2A, the steps 124 may be performed in parallel to one another (such that each step 124 is independent of one another). In some aspects, as shown in FIG. 2B, the steps 124 may be performed in series with one another (such that the output of a preceding step 124 is used as input into a following step 124). For example, the output from the first step 124a may be used as input into the second step 124b. There may be any suitable number of steps 124 performed in any combination of series and/or parallel relative to one another. Example steps 124 for insight 130 extraction may include feature extraction, user benefit analysis, insight characteristic inference, insight categorization, insight refinement and description, etc.

The additional trained models 112b are machine learning agents in accordance with some embodiments. Upon receival (e.g., at the processing resource 108) of the series of steps 124 from the at least one large language model (e.g., language model 114), the additional trained model(s) 112b generate (e.g., in cooperation with the processing resource 108) a step specific prompt 126 (e.g., a first step specific prompt 126a and/or a second step specific prompt 126b) for each of the steps 124 (e.g., steps 124a, 124b) in the series. As shown in FIG. 2A, the first step 124a corresponds with the first step specific prompt 126a and the second step 124b corresponds with the second step specific prompt 126b. Generally, each step 124 corresponds with a respective step specific prompt 126. In some aspects, each of the additional trained models 112b may be considered generation agents.

The step specific prompts 126 are generated with data (e.g., the product data 106) corresponding to a target product 105 (e.g., of the products 104) to query the at least one large language model (e.g., the language model 114) to provide a step specific insight factor (e.g., the first step specific insight factor 128a, the second step specific insight factor 128b, and/or the last step specific insight factor 128n) with respect to the target product 105. In some aspects, the step specific prompts 126 are textual prompts. Generally, the step specific prompts 126 are provided to a respective trained model 112, language model 114, and/or language model 114 in communication with a respective trained model 112. In some aspects, one trained model 112 and/or language model 114 generates and/or executes the step specific prompts 126. In some embodiments, multiple trained models 112 and/or language models 114 generate and/or execute the step specific prompts 126 (e.g., each step specific prompt 126 is generated/executed by a respective trained model 112/language model 114, a trained model 112/language model 114 generates/executes at least one step specific prompt 126, etc.).

For example, step specific prompts 126 corresponding to the example steps 124 above (e.g., feature extraction, user benefit analysis, insight characteristic inference, insight categorization, and/or insight refinement and description) may be as follows. A feature extraction step may have a step specific prompt 126 of “Given the following product description, list the key features and characteristics of this product, separate each feature with a semicolon”. A user benefit analysis step may have a step specific prompt 126 of “For each of the following product features, describe potential benefit or appeal to a user, provide your answer in a list format”. An insight categorization step may have a step specific prompt 126 of “Based on the following list of user benefits, infer characteristics (e.g., related to the specific insight being extracted) relevant to the user benefits, list these characteristics, one per line”. An insight categorization step may have a step specific prompt 126 of “Given the following list of characteristics, group these characteristics into distinct insight categories. For each category provide a descriptive label that encapsulates the key traits of that insight. Present your answer in a list of insight labels, each followed by the relevant characteristics”. An insight refinement and description step may have a step specific prompt 126 of “For each of the following insight categories, create a brief description of this insight, highlighting its key characteristics and relevancy to the target product. Present your answer as a list with the insight label followed by its description.” It is generally understood that the described step specific prompts 126 are for example only, and that any alternate and/or additional step specific prompts 126 for any alternate and/or additional steps 124 may be used (e.g., with alternate formatting, purpose, amount of step specific prompts 126, and so forth).

In some aspects, the processing resource 108 receives step specific insight factors with respect to the target product 105 (e.g., the first insight factor 128a associated with the first step 124a and/or the second insight factor 128b associated with the second step 124b). In some aspects, as shown in FIG. 2B, a last step specific insight factor 128n of multiple step specific insight factors includes an insight 130 for the target product 105. In some aspects, multiple insights 130 are generated for a target product 105 (e.g., multiple insights 130 of the same type and/or multiple types of insights 130). In some aspects, as shown in FIG. 2B, each step specific insight factor is used as input (along with a respective step specific prompt 126) into a language model 114 to determine a proceeding step specific insight factor. For example, a first step specific prompt 126a is used by a language model 114 to generate a first step specific insight factor 128a. The first step specific insight factor 128a is used by a language model 114 along with the second step specific prompt 126b to generate the second step specific insight factor 128b. The second step specific insight factor 128b is used by a language model 114 along with a last step specific prompt (not shown) to generate a last step specific insight factor 128n. There may be any number of step specific insight factors, however, generally each step 124 corresponds with a step specific prompt 126 and a consequently generated step specific insight factor.

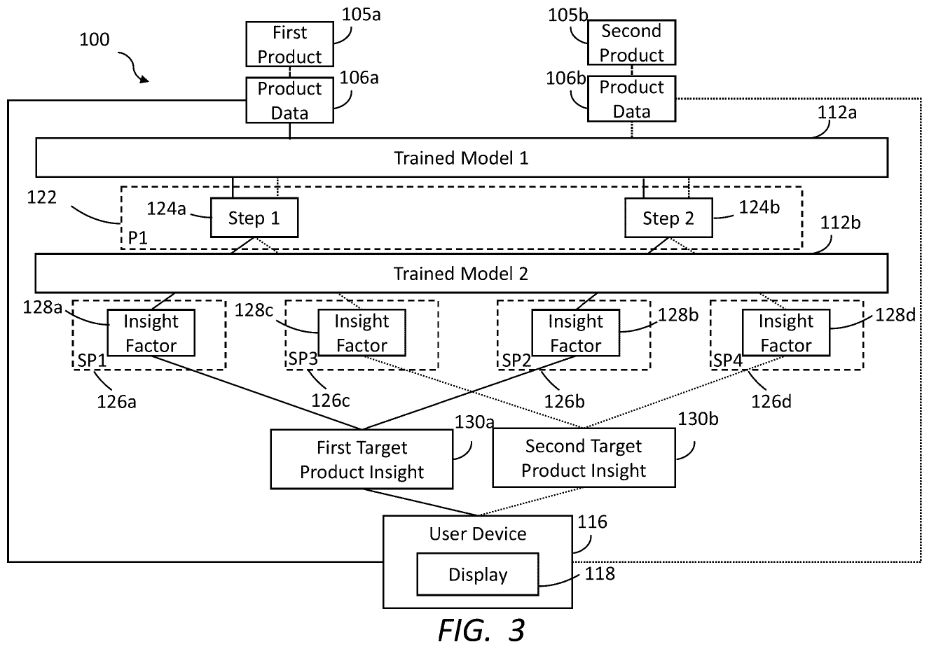

Further referring to FIG. 3, the system 100 may be used to generate an insight 130 for any number of target products 105 (wherein the target products may be referred to more generically as a target items). As shown, there may be a first target product 105a with corresponding product data 106a (more generically, item data), and a second target product 105b with corresponding product data 106b (more generically, item data). The solid lines connecting the components of the system 100 shown in FIG. 3 generally correspond to generation of a first target product insight 130a for the first target product 105a, and the dashed lines connecting the comments of the system 100 shown in FIG. 3 generally correspond to generation of a second target product insight 130b for the second target product 105b. As shown, the first trained model 112a generates the first prompt 122 to generate the steps 124 (e.g., 124a, 124b) for each of the first target product 105a and the second target product 105b. In some aspects, the first prompt 122 is the same for each of the first target product 105a and the second target product 105b, however, in some aspects the first prompt 122 includes information specific to each of the first target product 105a and the second target product 105b, respectively.

As shown, the steps 124a, 124b are the same for the first target product 105a and the second target product 105b, however, it is generally contemplated that different steps 124 may be generated for each target product 105. As shown, the additional trained models 112b and/or language model(s) 114 generate (e.g., with the processing resource 108) additional step specific prompts 126 (e.g., a third step specific prompt 126c associated with the first step 124a and/or a fourth step specific prompt 126d associated with the second step 124b) with data 106b corresponding with the second target product 105b to query at least one language model 114 to provide an additional step specific insight factor (e.g., a third step specific insight factor 128c corresponding with the first step 124a and/or a fourth step specific insight factor 128d corresponding with the second step 124b) with respect to the second target product 105b. Upon receival, for each of the steps 124 of the step specific insight factors associated with the second target product 105b (e.g., the insight factors 128c, 128d), at least second target product insight 130b associated with the second target product 105b is determined from a last step specific insight factor 128n associated with the second target product 105b. In some aspects, the system 100 utilizes multi-hop reasoning (e.g., multiple steps 124 individually performed by trained models 112 and/or language models 114 from multiple prompts).

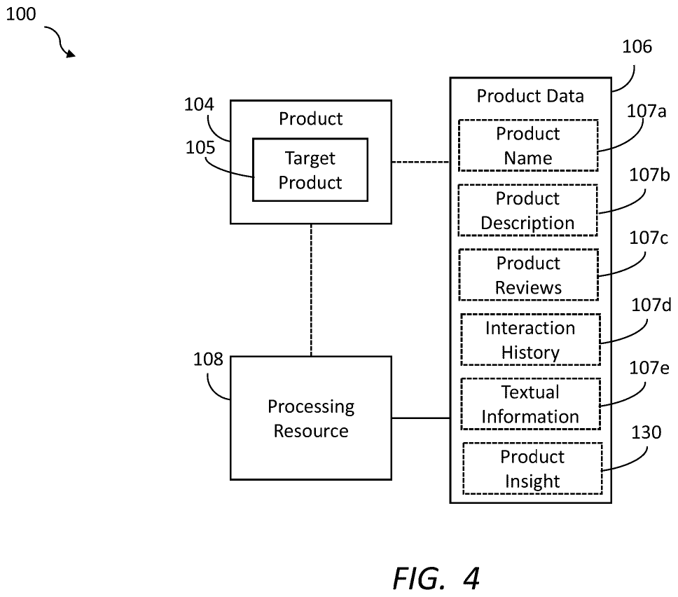

In some aspects, the processing resource 108 causes a display 118 of a user device 116 to display the target product 105, product data 106 (e.g., the product description 107b and/or textual information 107e shown in FIG. 4), and the insight 130. In some embodiments, the processing resource 108 outputs data (e.g., the product data 106a) to cause the display 118 of a user device 116 to display the first target product 105a, an associated product description 107b, associated textual information 107e, and the first target product insight 130a. The processing resource 108 may further output data (e.g., the product data 106b) to cause the display 118 of a user device 116 to display the second target product 105b, an associated product description 107b, associated textual information 107e, and the second target product insight 130b. In some embodiments, the processing resource 108 may further output, on the display 118 of a user device 116 the first target product insight 130a associated with the first target product 105a and the second target product insight 130b associated with the second target product insight 130b for comparison. Any number of target products 105, associated insights 130, and respective product data 106 may be output to a display 118 of a user device 116, in some aspects, for comparison between target products 105. For example, a user searching for a television may compare a first television with a use case 131a of “good for movies”, key differentiators of “entertainment options, deepest blacks, widest viewing angle”, and highlights 131d of “volume, remote, backlight”, a second television with a use case 131a of “good for streaming”, key differentiators of “motion handling, video processing, limited-time discount”, and highlights 131d of “quality, connection, value”, and a third television with a use case 131a of “good for bright rooms”, key differentiators of “peak brightness, reflection handling, outdoor usage”, and highlights 131d of “brightness, outdoor, voice control”. A user may consider the product data 106 output associated with each respective product 104 to determine which product 104 is best for the specific user to purchase.

In one example, the target product 105 may be a shoe. A use case 131a insight 130 may be “casual wear, sightseeing”, a persona 131b insight 130 may be “active family members, busy professionals”, a reasoning 131c insight 130 may be “comfortable fit, breathable material, durable sole”, and a highlight 131d insight 130 may be “durable, lightweight, stylish”. In another example, the system 100 may be used to generate personas 131b for a children's outdoor swing. Product reviews 107c of “for Christmas”, “for my grandchildren”, and so forth may extract a persona 131b of gift buyer. A product description 107b of “capable of holding up to 700 lbs” may extract a persona 131b of safety-conscious. Product reviews 107c of “put the iPads down”, “get outside and play”, and so forth may extract a persona 131b of active. In other words, the non-transactional data can be abstracted by the system 100, through iterative reasoning, to extract contextual insights 130. Generally, the extraction process is relational such that the system 100 creates new, contextually meaningful information rather than simply extracting text. In some aspects, the system 100 generates a first insight 130, and used the first insight 130 to refine and expand upon it to generate related insights 130. Further, the system 100 may explain why the generated insights 130 are relevant (e.g., a customer commenting on “outdoor fun” provided by an outdoor children's swing may logically provide reasoning to purchase the product of “values physical activity”).

FIG. 4 shows the system in accordance with some embodiments. In some embodiments, the processing resource 108 automatically updates the product data 106 to associate the insight 130 with the target product 105 of the products 104. As shown, the product data 106 stored in the database(s) 102 may include product name 107a, product description 107b, product reviews 107c, interaction history 107d, textual information 107e (e.g., any additional text information related to the products 104 and/or the insight generation process (e.g., prompts for the trained models 112 and/or the language models 114), product insights 130, and so on. And as described above, the target products and product data may be referred to more generically as a target items and item data.

FIG. 5 shows the system 100 in accordance with some embodiments. As shown, the processing resource 108 may further generate (e.g., by an additional trained model 112 (which may be considered an evaluation agent)) a prompt to query at least one language model 114 to evaluate the insight 130 for relevance to the product data 106 (such as the product description 107b and/or the textual information 107e) and to produce a corresponding relevance score 138. The relevance score 138 may be in any respective scale (e.g., a max score of 1, a max score of 100%, and so forth). In some aspects, there is a relevancy score threshold 140 (generally in the same scale as the relevance score 138) used to determine if an insight 130 is relevant enough to be output to a user device 116. For example, if the relevancy score threshold 140 is 0.7, an insight 130 with a relevance score 138 greater than 0.7 may be output on the display 118 of a user device 116 while an insight 130 with a relevance score 138 less than 0.7 may not be output on the display 118 of the user device 116. In some aspects, the processing resource 108 (e.g., alone and/or in communication with the trained models 112 and/or language models 114) may determine if the relevance score 138 is above the relevancy score threshold 140. In some aspects, prior to an evaluation of the insight 130 for relevance to the product data 106 (i.e., prior to generation of the 138) the processing resource 108 applies an embedding-based similarity method 142 (e.g., normalization, vector embedding, etc.) to the insight 130. In some aspects, trained models 112, a language model 114, and/or alternate embedding models may be utilized to perform the embedding-based similarity method 142. Embedding-based similarity is a method to measure how similar items are (in this case these would be either use cases 131a, highlights 131d, reasonings 131c, or personas 131b generated by the trained models 112 and language models 114) by converting them into numerical vectors (embeddings) and comparing those vectors mathematically. Normalization in this context involves: 1. Collecting all insights 131 (e.g., use cases 131a, highlights 131d, reasonings 131c, or personas 131b) and their frequencies within a product type (e.g., the target product 105); 2. Using embedding vectors to measure similarity between insights 130; and 3. Consolidating similar insights 130 by mapping less frequent ones to more frequent variants. For example, two generated insights 130 for a target product 105 may be “wedding decorations” (frequency 500) and “wedding accessories” (frequency 300) which have similar embedding vectors. Since “wedding decorations” appears more frequently, “wedding accessories” gets mapped to the target product 105, which reduces redundancy while preserving the most commonly used terms in a taxonomy.

In some aspects, the processing resource 108 may determine (e.g., by the trained models 112 and/or the language models 114) that the insight 130 is within a recommendation threshold 144 of the interaction history 107d (e.g., search history, view history, order history, cart history, etc.). The target product 105 associated with the insight 130 may be output on the display 118 of a user device 116 in response to a determination that the insight 130 is within the recommendation threshold 144 of the interaction history 107d. In other words, if an insight 130 is determined to be relevant to a specific customer, the products 104 associated with the insight 130 may be displayed to the customer.

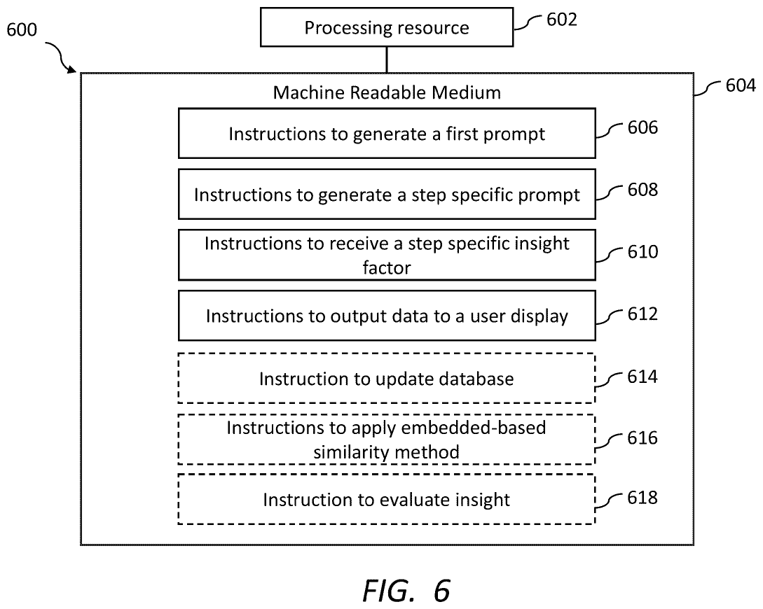

FIG. 6 shows a system 600 in accordance with some embodiments. The system 600 may, in some embodiments, be the system 100 and/or include components thereof. The system 600 generally includes a non-transitory computer-readable medium (e.g., the machine readable medium 604) programmed with computer-executable instructions (e.g., instructions 606, 608, 610, 612, 614, 616, and/or 618) for operating a computing device that includes a processing resource 602 and the non-transitory computer-readable medium (e.g., the readable medium 604) bearing the instructions 606, 608, 610, 612, 614, 616, 618 executable by the processing resource 602.

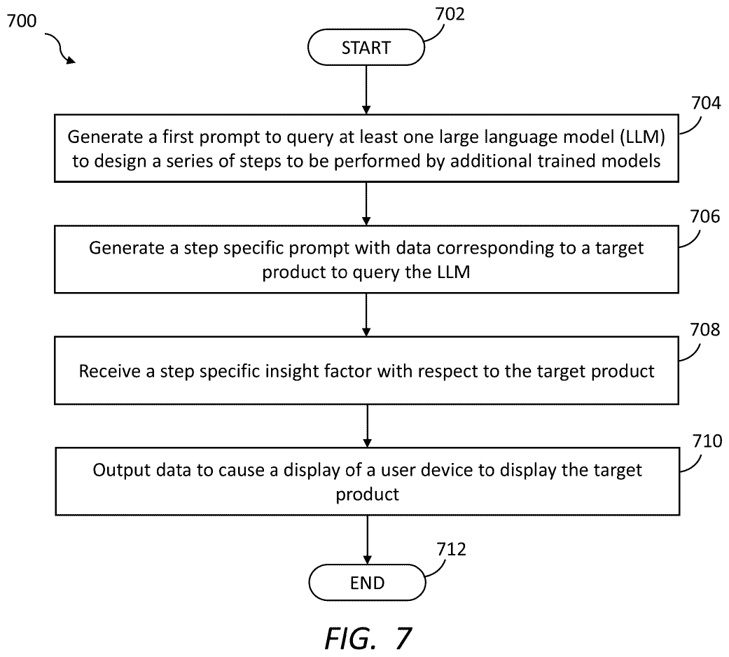

Further referring to FIG. 7, in some embodiments, the instructions 606, 608, 610, 612, 614, 616, 618, when executed by the processing resource 602, implement a method 700 of data generation and abstraction for products of an e-commerce platform. The method 700 begins at a starting step 702, and the instructions 606, when executed by the processing resource 602, implement a step 704 of generating, using a first trained model, a first prompt to query a large language model (LLM) to design a series of steps to be performed by additional trained models to determine one or more insights associated with a plurality of products based on at least one of the product descriptions and textual information associated with the plurality of products. In some aspects, each step includes a step specific prompt to be used to query the at least one LLM. The instructions 608, when executed by the processing resource 602, implement a step 706 of generating, for each of the series of steps using an additional trained model, the step specific prompt with data corresponding to a target product to query the at least one LLM to provide a step specific insight factor with respect to the target product. The instructions 610, when executed by the processing resource 602, implement a step 708 of receiving, for each of the series of steps, the step specific insight factor with respect to the target product. In some aspects, a last step specific insight factor includes an insight of the one or more insights for the target product. The instructions 612, when executed by the processing resource 602, implement a step 710 of outputting data to cause a display of a user device to display the target product, the at least one of product descriptions and textual information, and the insight. The method 700 ends at an ending step 712

Optionally, instructions 614, when executed by the processing resource 602, implement a step of automatically updating product data associated with a plurality of products stored in a database to associate the insight with the target product. Optionally, instructions 616, when executed by the processing resource 602, implement a step of applying an embedding-based similarity method to the insight prior to an evaluation of the insight for relevance to the at least one of product descriptions and textual information. Optionally, instructions 618, when executed by the processing resource 602, implement a step of generating, using an additional trained model, a prompt to query the at least one LLM to evaluate the insight for relevance to the at least one of product descriptions and textual information and to product a corresponding relevance score.

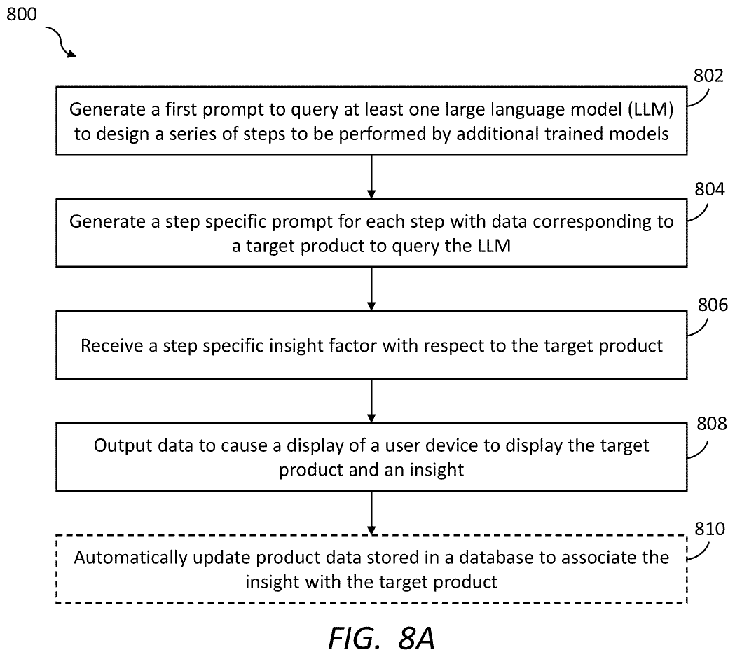

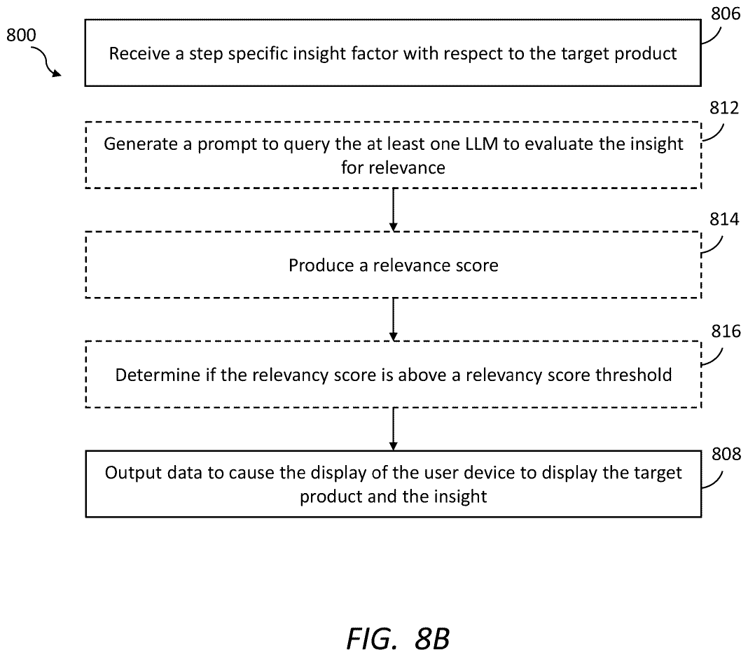

FIGS. 8A and 8B show a method 800 of data generation and abstraction for products of an e-commerce platform in accordance with some embodiments. It is generally contemplated that the method 800 may be implemented by the systems 100, 600 and/or components of the systems 100, 600.

Referring to FIG. 8A, at step 802, the method 800 includes generating, using a first trained model, a first prompt to query at least one large language model (LLM) to design a series of steps to be performed by additional trained models to determine one or more insights associated with a plurality of products based on at least one of product descriptions and textual information associated with the plurality of products. In some embodiments, the insight includes one or more of a use case of the target product, a person associated with the target product, a reasoning associated with the target product, and a highlight associated with the target product. In some aspects, each step includes a step specific prompt to be used to query the at least one LLM. At step 804, the method 800 includes generating, for each of the series of steps using an additional trained model, the step specific prompt with data corresponding to a target product to query the at least one LLM to provide a step specific insight factor with respect to the target product. At step 806, the method 800 includes receiving, for each of the series of steps, the step specific insight factor with respect to the target product. In some embodiments, a last step specific insight factor of a plurality of step specific insights includes an insight of one or more of the insights for the target product. At step 808, the method 800 includes outputting data to cause a display of a user device to display the target product, the at least one of product descriptions and the textual information, and the insight. Optionally, the method 800 may include a step 810 of automatically updating product data associated with a plurality of products stored in a database to associate the insight with the target product.

Referring to FIG. 8B, the method 800 optionally includes a step 812 of generating, using an additional trained model, a prompt to query the at least one LLM to evaluate the insight for relevance to the at least one of product descriptions and textual information. The method 800 optionally includes a step 814 of producing a relevance score corresponding to the evaluation of the insight. The method 800 optionally includes a step 816 of determining that the corresponding relevance score associated with the insight is above a relevancy score threshold. If it is determined that the relevance score is above a relevancy score threshold, step 808 may follow step 816, and data may be output to cause the display of the user device to display the target product and associated insight.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

1. A system comprising:
a database storing data associated with a plurality of items;
a processing resource; and
a machine readable medium storing instructions that, when executed by the processing resource, cause the processing resource to:
generate, using a first trained model, a first prompt to query at least one large language model (LLM) to design a series of steps to be performed by additional trained models to determine one or more insights associated with the plurality of items based on at least one of item descriptions and textual information associated with the plurality of items, wherein each step includes a step specific prompt to be used to query the at least one LLM;
receive the series of steps from the at least one LLM;
generate, for each of the series of steps using an additional trained model, the step specific prompt with data corresponding to a target item to query the at least one LLM to provide a step specific insight factor with respect to the target item;
receive, for each of the series of steps, the step specific insight factor with respect to the target item, wherein a last step specific insight factor of a plurality of step specific insights comprises an insight of the one or more insights for the target item; and
output data to cause a display of a user device to display the target item, the at least one of item descriptions and the textual information, and the insight.

2. The system of claim 1, wherein the insight comprises one or more of a use case of the target item, a persona associated with the target item, a reasoning associated with the target item, and a highlight associated with of the target item.

3. The system of claim 1, wherein the processing resource automatically updates the data to associate the insight with the target item.

4. The system of claim 1, wherein the instructions, when executed by the processing resource, further cause the processing resource to generate, using an additional trained model, a prompt to query the at least one LLM to evaluate the insight for relevance to the at least one of item descriptions and textual information and to produce a corresponding relevance score.

5. The system of claim 4, wherein the instructions, when executed by the processing resource, further cause the processing resource to output data to cause the display of the user device to display the target item in response to a determination that the corresponding relevance score associated with the insight is above a relevancy score threshold.

6. The system of claim 4, wherein the instructions, when executed by the processing resource, cause the processing resource to apply an embedding-based similarity method to the insight prior to an evaluation of the insight for relevance to the at least one of item descriptions and textual information.

7. The system of claim 6, wherein the embedding-based similarity method comprises normalization and vector embedding.

8. The system of claim 1, wherein the data comprises interaction history and wherein the instructions, when executed by the processing resource, further cause the processing resource to:
determine that the insight is within a recommendation threshold of the interaction history; and
output, on the display on the user device, the target item associated with the insight in response to the determination that the insight is within the recommendation threshold of the interaction history.

9. The system of claim 1, wherein the instructions, when executed by the processing resource, further cause the processing resource to:
generate, for each of the series of steps using the additional trained model, the step specific prompt with data corresponding to a second target item to query the at least one LLM to provide a second step specific insight factor with respect to the second target item;
receive, for each of the series of steps, the second step specific insight factor with respect to the second target item, wherein a last second step specific insight factor of a plurality of second step specific insights comprises a second insight of a one or more insights for the second target item; and
output data to cause the display of the user device to display the second target item, the at least one of item descriptions and the textual information associated with the second target item, and the second insight.

10. The system of claim 9, wherein the instructions, when executed by the processing resource, further cause the processing resource to:
output, on the display on the user device, the insight associated with the target item and the insight associated with the second target item for comparison.

11. The system of claim 1, wherein the data stored in the database includes at least one of item descriptions, item name, item reviews, and interaction history.

12. A method comprising:
generating, using a first trained model, a first prompt to query at least one large language model (LLM) to design a series of steps to be performed by additional trained models to determine one or more insights associated with a plurality of items based on at least one of item descriptions and textual information associated with the plurality of items, wherein each step includes a step specific prompt to be used to query the at least one LLM;
generating, for each of the series of steps using an additional trained model, the step specific prompt with data corresponding to a target item to query the at least one LLM to provide a step specific insight factor with respect to the target item;
receiving, for each of the series of steps, the step specific insight factor with respect to the target item, wherein a last step specific insight factor of a plurality of step specific insights comprises an insight of the one or more insights for the target item; and
outputting data to cause a display of a user device to display the target item, the at least one of item descriptions and the textual information, and the insight.

13. The method of claim 12, wherein the insight comprises one or more of a use case of the target item, a persona associated with the target item, a reasoning associated with the target item, and a highlight associated with of the target item.

14. The method of claim 12, further comprising automatically updating data associated with a plurality of items stored in a database to associate the insight with the target item.

15. The method of claim 12, further comprising generating, using an additional trained model, a prompt to query the at least one LLM to evaluate the insight for relevance to the at least one of item descriptions and textual information and to produce a corresponding relevance score.

16. The method of claim 15, further comprising outputting data to cause the display of the user device to display the target item in response to a determination that the corresponding relevance score associated with the insight is above a relevancy score threshold.

17. A non-transitory machine readable medium storing instructions for a system, when executed, cause a processing resource to:
generate, using a first trained model, a first prompt to query at least one large language model (LLM) to design a series of steps to be performed by additional trained models to determine one or more insights associated with a plurality of items based on at least one of item descriptions and textual information associated with the plurality of items, wherein each step includes a step specific prompt to be used to query the at least one LLM;
generate, for each of the series of steps using an additional trained model, the step specific prompt with data corresponding to a target item to query the at least one LLM to provide a step specific insight factor with respect to the target item;
receive, for each of the series of steps, the step specific insight factor with respect to the target item, wherein a last step specific insight factor of a plurality of step specific insights comprises an insight of the one or more insights for the target item; and
output data to cause a display of a user device to display the target item, the at least one of item descriptions and the textual information, and the insight.

18. The non-transitory machine readable medium of claim 17, wherein the instructions, when executed, cause the processing resource to automatically update data associated with a plurality of items stored in a database to associate the insight with the target item.

19. The non-transitory machine readable medium of claim 17, wherein the instructions, when executed, cause the processing resource to generate, using an additional trained model, a prompt to query the at least one LLM to evaluate the insight for relevance to the at least one of item descriptions and textual information and to produce a corresponding relevance score.

20. The non-transitory machine readable medium of claim 19, wherein the instructions, when executed, cause the processing resource to apply an embedding-based similarity method to the insight prior to an evaluation of the insight for relevance to the at least one of item descriptions and textual information.
